(19) United States
(12) Patent Application Publication
(10) Pub. No.: US 2014/0212552 A1
(43) Pub. Date: Jul. 31, 2014

(54) COOKWARE RELEASE COMPOSITIONS

(71) Applicant: ConAgra Foods RDM, Inc., Omaha, NE (US)

(72) Inventors: Jeffrey J. Kester, West Chester, OH (US); Bulent Binbuga, Omaha, NE (US); Prem Singh, Glen Ellyn, IL (US); Atul H. Mistry, Omaha, NE (US); Flora Ware, Elkhorn, NE (US)

(73) Assignee: ConAgra Foods RDM, Inc., Omaha, NE (US)

(21) Appl. No.: 14/242,344

(22) Filed: Apr. 1, 2014

Related U.S. Application Data
(63) Continuation of application No. 13/157,800, filed on Jun. 10, 2011, now abandoned.

(51) Int. Cl. A23D 9/007; B65D 83/14

(52) U.S. Cl. CPC A23D 9/007; B65D 83/752
USPC 426/116

(57) ABSTRACT

A cookware release composition having edible oil and a silicone polymer. The cookware release composition can contain an edible oil and greater than 1000 ppm polydimethylsiloxane. The cookware release composition can contain an edible oil and a silicone polymer and the edible oil can be selected from the group consisting of palm oil, fractionated palm oil, high-oleic vegetable oil, lauric acid oil, MCT, and combinations thereof. The cookware release composition can contain an edible oil that contains less than 25% polyunsaturated fatty acids and polydimethylsiloxane.

### FIELD

The present disclosure relates to cookware release compositions. The cookware release compositions can comprise an edible oil and a silicone polymer.

### BACKGROUND

Conventional cookware release compositions, such as cooking sprays, typically contain an edible oil, a non-stick or release agent, and a propellant. Cookware release compositions may be applied to the surface of cooking utensils to prevent or reduce food from sticking to the surface during and after cooking by frying, baking, broiling, roasting, and the like. The edible oil is typically an unsaturated vegetable oil, such as canola oil, soybean oil, cottonseed oil, sunflower oil, corn oil, and the like. These liquid oils contain a significant amount of polyunsaturated fatty acids with multiple carbon-carbon double bonds, such as linoleic acid (C18:2) and linolenic acid (C18:3). Because of their double bonds, unsaturated fatty acids are susceptible to thermal oxidation during cooking. This susceptibility can be exacerbated when the unsaturated fatty acids are in an oil that exists as a thin film deposited uniformly over a heated surface, as is the case when cookware release compositions are applied to the surface of cooking utensils, such as a glass casserole dish, an aluminum baking sheet, or a stainless steel frying pan. The thermal oxidation can result in polymerization of the cookware release composition at typical cooking temperatures (e.g. from about 350° F. to about 500° F.) and typical cooking times (e.g. from about 5 minutes to about 60 minutes). Furthermore, higher cooking temperatures and/or longer cooking times tend to promote greater thermal oxidation and oil polymerization. Oil polymerization can cause a sticky, gummy, and/or viscous residue film to form on the surface of the cooking utensils. This residue film is difficult to remove by washing in an automatic dishwasher or by washing and scrubbing by hand. Over time and with repeated use, residue on the cooking utensil surface can build up and darken, resulting in an unappealing appearance, and can cause increased sticking of food.

Various compositions have been formulated in an attempt to solve the residue buildup problems. However, these compositions, at best, provide only a partial solution. Some cookware release compositions comprise palm kernel oil or coconut oil. However, using these oils alone as the sole approach to control residue may result in performance issues during cooking, such as a low smoke point. Other cookware release compositions contain an oil composition in which medium chain triglycerides have been interesterified with long-chain edible oils to form interesterified structured lipids, and, in another cookware release composition, oil is blended with an edible solvent consisting of triacetin, tripropionin, tributyrin, and/or ethyl acetate. However, the use of interesterified structured lipids or edible solvents may not be economically feasible and may also present cooking performance or taste issues. Other cookware release compositions comprise high-oleic vegetable oil and/or a fractionated oil, such as a fractionated palm oil. However, incorporating high-oleic vegetable oil or fractionated palm oil into cookware release compositions may not in itself be sufficient to afford maximal resistance to residue formation at high cooking temperatures or for long cooking times because oleic acid, while more oxidatively stable than linoleic and linolenic acids, is also unsaturated and therefore susceptible to oxidation and polymerization under high thermal stress.

Therefore, a need exists for cookware release compositions that prevent or reduce food from sticking in various cooking applications, including baking and frying, and that reduce or eliminate residue formation resulting in a reduction or elimination of cookware release composition residue on the cooking utensil surface after washing.

### SUMMARY

One embodiment of the invention relates to a cookware release composition. The cookware release composition can include an edible oil and a silicone polymer. The silicone polymer can be present at greater than 1000 ppm, based on the weight of the cookware release composition.

In another embodiment, the cookware release composition can include an edible oil and a silicon polymer, wherein the edible oil is selected from the group consisting of palm oil, fractionated palm oil, high-oleic vegetable oil, lauric acid oil, medium chain triglyceride, and combinations thereof and wherein the edible oil is not solely olive oil, is not solely coconut oil, or is not solely combinations thereof.

In still another embodiment, the cookware release composition can include an edible oil and a silicon polymer, wherein the edible oil comprises less than 25% polyunsaturated fatty acids and wherein the edible oil is not solely olive oil, is not solely coconut oil, or is not solely combinations thereof.

Numerous advantages and additional aspects of embodiments of the present invention will be apparent from the description of the embodiments herein and the drawings that follow.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 includes photographs of the CorningWare® Simply Lite™ glass bakeware following the Measurement of Residue on Glass Cooking Utensil Method described hereafter;

FIG. 2 includes photographs of the NordicWare® aluminum Baker's Quarter Sheet following the Measurement of Residue on Aluminum Baking Utensil Method described hereafter.

### DETAILED DESCRIPTION

As used herein, the articles including “the”, “a”, and “an”, when used in a claim or in the specification, are understood to mean one or more of what is claimed or described.

As used herein, the terms “include”, “includes”, and “including” are meant to be non-limiting.

As used herein, the term “plurality” means more than one.

As used herein, the term “cookware release composition” refers to compositions useful for preventing or reducing food from sticking to surfaces during the preparation of cooked and uncooked foods, including but not limited to cooking oils, cooking sprays, pan release sprays, and belt release sprays. An example of a commercially available cookware release composition is PAM® Original from ConAgra Foods®, Inc. (Omaha, Nebr.).

As used herein, the term “cooking utensil” refers to items that aid in the preparation of cooked and uncooked foods, including but not limited to pots, pans, ovenware, bakeware, cookware, tongs, spatulas, turners, spoons, ladles, forks, knives, whisks, splatter screens, colanders, strainers, pastry tools, graters and peelers, cutting boards, slow cookers, grills, dishes, and woks. The cooking utensils can be made from metal, glass, plastic, and combinations thereof.

The composition, processes, and methods of the present invention can comprise, consist of, or consist essentially of, the elements of the invention described herein, as well as any additional or optional ingredients, components, or limitations described herein or otherwise useful in the compositions herein.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All lists of items, such as, for example, lists of ingredients, are intended to and should be interpreted as Markush groups. Thus, all lists can be read and interpreted as items “selected from the group consisting of” . . . list of items . . . “and combinations and mixtures thereof.”

Referenced herein may be trade names for components including various ingredients utilized in the present disclosure. The inventors herein do not intend to be limited by materials under any particular trade name. Equivalent materials (e.g., those obtained from a different source under a different name or reference number) to those referenced by trade name may be substituted and utilized in the descriptions herein.

In the description of the various embodiments of the present disclosure, various embodiments or individual features are disclosed. As will be apparent to the ordinarily skilled practitioner, all combinations of such embodiments and features are possible and can result in preferred executions of the present disclosure. While various embodiments and individual features of the present invention have been illustrated and described, various other changes and modifications can be made without departing from the spirit and scope of the invention.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

### Cookware Release Composition

Embodiments of the present invention relate to cookware release compositions. The cookware release compositions can be applied to the surface of cooking utensils in order to prevent or reduce the sticking of food. The cookware release compositions can comprise one or more edible oils and a silicone polymer. In another embodiment, the cookware release compositions can comprise an emulsifier. In another embodiment, the cookware release compositions can comprise other ingredients. In one embodiment, the cookware release compositions develop little or no residue after application to a cooking utensil and following heat treatment and washing of the cooking utensil. In another embodiment, the cookware release compositions, after application to a cooking utensil, develop residue that is easily removed during washing.

The Measurement of Residue on Glass Cooking Utensil Method described hereafter can be used to measure the percent of cookware release composition remaining as residue on a glass cooking utensil after washing. In an embodiment, the cookware release compositions have a percent of cookware release composition as residue of less than about 50%, in another embodiment less than about 40%, in another embodiment less than about 30%, in another embodiment less than about 25%, in another embodiment less than about 20%, in another embodiment less than about 15%, in another embodiment less than about 10%, in yet another embodiment less than about 7%, and in a further embodiment less than about 5%.

The Measurement of Residue on Aluminum Baking Utensil Method described hereafter can be used to measure the percent of cookware release composition remaining as residue on a glass cooking utensil after washing. In an embodiment, the cookware release compositions have a percent of cookware release composition as residue of less than about 50%, in another embodiment less than about 40%, in another embodiment less than about 30%, in another embodiment less than about 25%, in another embodiment less than about 20%, in another embodiment less than about 15%, in another embodiment less than about 10%, in yet another embodiment less than about 7%, and in a further embodiment less than about 5%.

### Components of the Cookware Release Composition

Edible Oils

The cookware release compositions can comprise one or more edible oils. In certain embodiments, the edible oils can be selected from the group consisting of palm oil, fractionated palm oil, high-oleic vegetable oil, lauric acid oils, medium chain triglyceride (MCT), and combinations thereof. Non-limiting examples of fractionated palm oil can include palm olein, super palm olein, and combinations thereof.

In one embodiment, the cookware release composition can comprise edible oils in an amount of from about 50% to about 99.99%, by weight of the composition, in another embodiment from about 70% to about 97%, by weight of the composition, in yet another embodiment from about 80% to about 96%, by weight of the composition, in another embodiment from about 90% to about 95%, by weight of the composition, and in a further embodiment from about 93% to about 95%, by weight of the composition. Edible oils can refer to one or more food-grade oils derived from plants or animals that when blended together yield a pourable composition at room temperature (70° F.).

In an embodiment, the one or more edible oils can help decrease the formation of residue on cooking utensil surfaces during heating. In another embodiment, the one or more edible oils can comprise two or more edible oils, i.e. a combination of oils. Any number of and combination of edible oils can be used.

In another embodiment, the edible oils can comprise one or more low-polyunsaturate oils. In an embodiment, the low-polyunsaturate oils contain less than about 25% polyunsaturated fatty acids (C18:2 and C18:3), in another embodiment less than about 20% polyunsaturated fatty acids (C18:2 and C18:3), in another embodiment less than about 15% polyunsaturated fatty acids (C18:2 and C18:3), and in yet another embodiment less than about 10% polyunsaturated fatty acids (C18:2 and C18:3). Non-limiting examples of low-polyunsaturate oils can include high-oleic vegetable oils, palm oil (and fractions thereof, such as palm olein and super palm olein), lauric acid oils, MCT, mineral oil, and combinations thereof. Non-limiting examples of high-oleic vegetable oils can include high-oleic canola oil, high-oleic sunflower oil, high-oleic safflower oil, high-oleic soybean oil, high-oleic peanut oil, olive oil, and mixtures thereof. Non-limiting examples of lauric acid oils can include coconut oil (and fractions thereof, such as coconut olein), palm kernel oil (and fractions thereof, such as palm kernel olein), babassu oil, and combinations thereof. In an embodiment, the cookware release compositions can comprise low-polyunsaturate oils, in the amount of from about 25% to about 100%, by weight of the edible oil, in another embodiment from about 50% to about 100%, by weight of the edible oil, in another embodiment from about 75% to about 100%, by weight of the edible oil, in yet another embodiment from about 90% to about 100%, by weight of the edible oil.

In another embodiment, the edible oils can comprise less than about 25% polyunsaturated fatty acids (C18:2 and C18:3), by weight of the edible oil, in another embodiment less than about 20% polyunsaturated fatty acids (C18:2 and C18:3), by weight of the edible oil, in another embodiment less than about 15% polyunsaturated fatty acids (C18:2 and C18:3), by weight of the edible oil, and in yet another embodiment less than about 10% polyunsaturated fatty acids (C18:2 and C18:3).

In certain embodiments, the one or more edible oils can comprise high-oleic vegetable oil. High-oleic vegetable oils are liquid oils rich in oleic acid and with a relatively low content of polyunsaturated fatty acids, such as linoleic and linolenic acids. For example, an embodiment of high-oleic sunflower oil comprises about 84.8% by weight oleic acid, 6.9% linoleic acid, and 0.3% linolenic acid; compared to about 20% by weight oleic acid, 68% linoleic acid, and 0.5% linolenic acid in conventional sunflower oil. Oleic acid is a monounsaturated 18-carbon fatty acid, commonly referred to as C18:1. Linoleic and linolenic acids are polyunsaturated 18-carbon fatty acids, commonly referred to as C18:2 and C18:3, respectively. In an embodiment, the cookware release composition can comprise high-oleic vegetable oils in the amount of from about 50% to about 99.99%, by weight of the composition, in another embodiment from about 60% to about 97%, by weight of the composition, and in yet another embodiment from about 63% to about 95%, by weight of the composition, in another embodiment from about 50% to about 75%, by weight of the composition, in yet another embodiment from about 60% to about 70%, by weight of the composition, and in a further embodiment from about 63% to about 68%, by weight of the composition.

In one embodiment, the high-oleic vegetable oils can comprise greater than about 50% oleic acid, by weight of the high-oleic vegetable oil, in another embodiment greater than about 60% oleic acid, by weight of the high-oleic vegetable oil, in another embodiment greater than about 70% oleic acid, by weight of the high-oleic vegetable oil, in yet another embodiment greater than about 80% oleic acid, by weight of the high-oleic vegetable oil. In one embodiment, the high-oleic vegetable oils can comprise less than 25% polyunsaturated fatty acids (C18:2 and C18:3), by weight of the high-oleic vegetable oil, in one embodiment less than 20% polyunsaturated fatty acids, by weight of the high-oleic vegetable oil, in another embodiment, less than 15% polyunsaturated fatty acids, by weight of the high-oleic vegetable oil, and in yet another embodiment less than 10% polyunsaturated fatty acids, by weight of the high-oleic vegetable oil. In an embodiment, the high-oleic vegetable oils comprise less than about 4% by weight linolenic acid. In an embodiment, the high-oleic vegetable oils comprise less than about 15% saturated fatty acids, by weight of the high-oleic vegetable oils, in another embodiment less than about 10% saturated fatty acids, by weight of the high-oleic vegetable oils, and in a further embodiment less than about 6% saturated fatty acids, by weight of the high-oleic vegetable oils. Fatty acid percentages may be determined using AOCS Official Method Ce 1c-89, “Fatty Acid Composition by GLC”, Official Methods and Practices of the AOCS, 4^{th} Ed., 1995.

In an embodiment, the high-oleic vegetable oils can be derived from hybrid oilseeds. Hybrid oilseeds are developed through controlled selective plant breeding techniques intended to enrich the content of oleic acid and reduce the level of polyunsaturated fatty acids. As such, olive oil is not a high-oleic vegetable oil derived from hybrid oilseeds because olive oil naturally comprises a high level of oleic acid (e.g. from about 56% to about 83% by weight). Therefore, in an embodiment, the high-oleic vegetable oil is not olive oil. Non-limiting examples of high-oleic vegetable oils derived from hybrid oilseeds can include high-oleic canola oil, high-oleic sunflower oil, high-oleic safflower oil, high-oleic soybean oil, high-oleic peanut oil, and mixtures thereof. In an embodiment, the high-oleic vegetable oils can be refined, bleached, and deodorized (RBD).

Low-polyunsaturate oils can also be produced from conventional vegetable oils by partial hydrogenation. Hydrogenation refers to the process in which hydrogen is added to the double bonds of unsaturated fatty acids in the presence of a suitable catalyst, resulting in a reduced level of unsaturation and, therefore, a drop in the iodine value of the oil. Under controlled reaction conditions (e.g. temperature, pressure, agitation, catalyst type and level), there is preferential hydrogenation of the polyunsaturated fatty acids. As a result, partial hydrogenation of vegetable oils can yield a reduction in the content of linoleic and linolenic fatty acids, accompanied by an increase in the content of monounsaturated fatty acids. For example, one embodiment of a low-polyunsaturate oil produced by partial hydrogenation of a conventional vegetable oil is liquid, partially-hydrogenated soybean oil with an iodine value of about 80 that comprises about 69.3% by weight C18:1 fatty acid, 11.2% C18:2 fatty acid, and 0.2% C18:3 fatty acid (total of 11.4% by weight polyunsaturated fatty acids). Another embodiment is liquid, partially-hydrogenated soybean oil with an iodine value of 92 comprising about 61.2% by weight C18:1 fatty acid, 21.8% C18:2 fatty acid, and 0.5% C18:3 fatty acid (total of 22.3% by weight polyunsaturated fatty acids). Non-limiting examples of low-polyunsaturate oils produced by partial-hydrogenation of conventional vegetable oils can include partially-hydrogenated canola oil, partially-hydrogenated soybean oil, partially-hydrogenated cottonseed oil, partially-hydrogenated peanut oil, partially-hydrogenated corn oil, partially-hydrogenated sunflower oil, partially-hydrogenated safflower oil, partially-hydrogenated sesame oil, and combinations thereof.

In certain embodiments, the high-oleic vegetable oil comprises high-oleic canola oil. A non-limiting example is high-oleic, low-linolenic acid (HOLL) RBD canola oil commercially available from Bunge North America (St. Louis, Mo.), which comprises 73.6% by weight oleic acid, 13.7% linoleic acid, 1.5% linolenic acid (total polyunsaturated fatty acids equal to about 15.2%), and about 6% saturated fatty acids. Other non-limiting examples of commercially available high-oleic canola oils include those available under the trade names CLEAR VALLEY® 65 and CLEAR VALLEY® 80, both available from Cargill Inc. (Wayzata, Minn.). These are refined, bleached and deodorized oils produced from seeds of high-oleic acid, low-linolenic acid (HOLL) Brassica napus plant lines.

In some embodiments, the high-oleic vegetable oil comprises high-oleic sunflower oil. In certain embodiments, the high-oleic sunflower oil comprises about 80% by weight or greater oleic acid. Non-limiting examples of commercially available high-oleic sunflower oil include those available under the trade names CLEAR VALLEY™ high-oleic sunflower oil and ODYSSEY™ 100 high-stability sunflower oil, both from Cargill Inc. (Wayzata Minn.). Also useful is high-oleic sunflower oil commercially available under the trade designation TRISUN®, from Stratas Foods (Memphis, Tenn.).

In certain embodiments, the edible oil component can comprise palm oil and/or fractionated palm oil (e.g. palm olein; super palm olein). Palm oil is extracted from the pulp of the fruit of the oil palm, Elaeis guineensis. Typically, non-fractionated palm oil comprises from about 40% to about 48% by weight palmitic acid (C16:0) and from about 36% to about 42% by weight oleic acid (C18:1). Palm oil can be fractionated by heating to a complete melt, followed by controlled cooling to promote partial crystallization and subsequent filtration or pressing to yield liquid palm olein (single fractionated) or super palm olein (double fractionated) filtrates. Palm olein and super palm olein have an increased content of oleic acid and a reduced content of palmitic acid compared to non-fractionated palm oil. When palm oil is used at a relatively high level in the edible oil component (e.g. greater than about 15%, by weight of the composition, in an embodiment and greater than about 30%, by weight of the composition, in another embodiment), it may be useful to use either of the fractionated palm oils (palm olein and/or super palm olein) to minimize the potential for solids crystallization in the cookware release composition. Palm oil and fractionated palm oil can be refined, bleached, and deodorized. In an embodiment, the cookware release composition comprises fractionated palm oil which can include palm olein, super palm olein, or a combination thereof. In an embodiment, the fractionated palm oil can comprise from about 5% to about 99.99%, by weight of the composition, in another embodiment from about 5% to about 90%, by weight of the composition, in another embodiment from about 5% to about 75%, by weight of the composition, in another embodiment from about 5% to about 60%, by weight of the composition, in another embodiment from about 5% to about 50%, by weight of the composition, in another embodiment from about 10% to about 50%, by weight of the composition, in another embodiment from about 15% to about 50%, by weight of the composition, in another embodiment from about 15% to about 40%, by weight of the composition, and in yet another embodiment from about 20% to about 35%, by weight of the composition.

Examples of commercially available palm oil include SansTrans™ 39 from Loders Croklaan N.A. (Channahon, Ill.) and NovaLipid™ Palm Oil (product code 846500) from Archer Daniels Midland Company (Decatur, Ill.). Examples of commercially available palm olein include SansTrans™ 25 from Loders Croklaan N.A., which comprises about 43% by weight monounsaturated fatty acids and about 10.6% by weight polyunsaturated fatty acids, and Palm Olein (product code 840660) from Archer Daniels Midland Company. An example of a commercially available super palm olein is Durkex® NT100 from Loders Croklaan N.A., which comprises about 46% by weight monounsaturated fatty acids and about 12.5% by weight polyunsaturated fatty acids.

In certain embodiments, the edible oil component can comprise one or more lauric acid oils, which are vegetable oils characterized by a relatively high level of lauric (C12:0) and myristic (C14:0) fatty acids. Non-limiting examples of lauric acid oils include coconut oil (and fractions thereof), palm kernel oil (and fractions thereof), and babassu oil; each of which comprise from about 40% to about 56% by weight of lauric acid and from about 11% to about 27% by weight myristic acid. In an embodiment, the cookware release composition comprises a lauric acid oil in the amount of from about 5% to about 75%, by weight of the composition, in another embodiment from about 10% to about 60%, by weight of the composition, in another embodiment from about 15% to about 50%, by weight of the composition, and in yet another embodiment from about 20% to about 35%, by weight of the composition.

In certain embodiments, the edible oil component can comprise coconut oil and/or fractionated coconut oil. Coconut oil is extracted from the kernel of coconut harvested from the coconut palm (Cocos nucifera). Coconut oil can be fractionated by promoting partial crystallization, followed by filtration or pressing to yield more liquid coconut olein. Coconut oil and fractionated coconut oil can be refined, bleached, and deodorized. A non-limiting example of coconut oil comprises about 7% caprylic acid (C8:0), 6% capric acid (C10:0), 47% lauric acid (C12:0), 19% myristic acid (C14:0), 9% palmitic acid (C16:0), 3% stearic acid (C18:0), 7% oleic acid (C18:1), and 2% by weight linoleic acid (C18:2). Examples of commercially available coconut oil include LouAna® brand Pure Coconut Oil from Ventura Foods, LLC (Brea, Calif.) and NovaLipid™ 76° F. Coconut Oil (product code 890620) from Archer Daniels Midland Company (Decatur, Ill.).

In certain embodiments, the edible oil component can comprise palm kernel oil and/or fractionated palm kernel oil. Palm kernel oil is derived from the kernel of the oil palm (Elaeis guineensis). Palm kernel oil can be fractionated by promoting partial crystallization, followed by filtration or pressing to yield more liquid palm kernel olein. Palm kernel oil and fractionated palm kernel oil can be refined, bleached, and deodorized. A non-limiting example of palm kernel oil comprises about 3% caprylic acid (C8:0), 3% capric acid (C10:0), 47% lauric acid (C12:0), 16% myristic acid (C14:0), 10% palmitic acid (C16:0), 2% stearic acid (C18:0), 17% oleic acid (C18:1), and 3% by weight linoleic acid (C18:2). An example of a commercially available palm kernel oil is NovaLipid™ Palm Kernel Oil (product code 840650) from Archer Daniels Midland Company (Decatur, Ill.).

In certain embodiments, the edible oil component can comprise medium chain triglyceride (MCT). MCT is produced by esterifying glycerol with caproic acid (C6:0), caprylic acid (C8:0), capric acid (C10:0), lauric acid (C12:0), and combinations thereof. A non-limiting example of commercially available MCT is Neobee® M-5 Caprylic/Capric Triglycerides, available from Stepan Company (Maywood, N.J.). The typical fatty acid composition of Neobee® M-5 MCT is about 1% by weight caproic acid (C6:0), about 68% by weight caprylic acid (C8:0), about 30% by weight capric acid (C10:0), and about 1% by weight lauric acid (C12:0). Another example of a commercially available MCT is Neobee® 895 Caprylic Triglycerides from Stepan Company, which is typically comprised of about 97% by weight caprylic acid (C8:0) and about 3% by weight capric acid (C10:0).

In an embodiment, the one or more edible oils comprise one or more lauric acid oils, MCT, and combinations thereof. In one embodiment, the combined total of lauric acid oils and/or MCT is less than about 75%, by weight of the edible oils, in another embodiment less than about 60%, by weight of the edible oils, in another embodiment less than about 50%, by weight of the edible oils. These weight percentages can ensure an acceptable smoke point and non-smoking performance when cooking with the cookware release composition.

In certain embodiments, the cookware release composition can comprise a blend of two or more edible oils selected from the group consisting of palm oil, fractionated palm oil, high-oleic vegetable oil, lauric acid oils, MCT, and combinations thereof. In one embodiment, the cookware release composition can comprise a blend of from about 10 to about 90%, more particularly of from about 40 to about 85%, or from about 50 to about 80%, or from about 65 to about 75% by weight high-oleic vegetable oil, and from about 10 to about 90%, more particularly from about 15 to about 60%, or from about 20 to about 50%, or from about 25 to about 35% by weight coconut oil. In another embodiment, the cookware release composition can comprise a blend of from about 10 to about 90%, more particularly from about 40 to about 85%, or from about 50 to about 80%, or from about 65 to about 75% by weight high-oleic vegetable oil, and from about 10 to about 90%, more particularly from about 15 to about 60%, or from about 20 to about 50%, or from about 25 to about 35% by weight fractionated palm oil. In yet another embodiment, the cookware release composition can comprise a blend of from about 10 to about 90%, more particularly from about 40 to about 85%, or from about 50 to about 80%, or from about 65 to about 75% by weight fractionated palm oil, and from about 10 to about 90%, more particularly from about 15 to about 60%, or from about 20 to about 50%, or from about 25 to about 35% by weight coconut oil.

In an embodiment, the one or more edible oils can also comprise conventional vegetable oils (non-hydrogenated or partially-hydrogenated), such as canola oil, soybean oil, cottonseed oil, sunflower oil, safflower oil, corn oil, olive oil, peanut oil, sesame oil, and combinations thereof. The vegetable oils may be refined, bleached, and deodorized.

In an embodiment, the one or more edible oils can also comprise non-digestible oils, such as polyol fatty acid polyesters. More specifically, the edible oil can comprise sucrose polyesters that are liquid or semi-solid at room temperature (70° F.). An example of a commercially available sucrose polyester is Olean®, available from The Procter & Gamble Company (Cincinnati, Ohio).

### Silicone Polymer

The cookware release composition of the present invention can comprise one or more silicone polymers. Silicone polymers can include the family of organosiloxane polymers characterized by a repeating silicon-oxygen-silicon (Si—O—Si) backbone with organic radicals attached to the silicon atoms. In an embodiment, the silicone polymer can be polydimethylsiloxane (PDMS).

The silicone polymer provides another means to prevent or reduce the formation and/or adherence of residue on cooking utensil surfaces, thereby resulting in significantly less residue after washing the cooking utensil. This discovery was surprising and unexpected. While not wishing to be bound by theory, a possible mechanism for the protective effect afforded by the silicone polymer on a cooking utensil may be related to its very low surface tension (-20 dynes/cm² at 68° F.), thereby allowing for easy and efficient spreading. In addition, the low solubility of the silicone polymer in vegetable oils and its slightly higher specific gravity (0.965-0.972 at 77° F.) relative to the oil carrier (0.918-0.925) may enhance its interaction with the surface of the cooking utensil. As a result, the silicone polymer may be forming a thin film barrier at the surface of the cooking utensil that reduces the adherence of any polymerized oil that develops during thermal treatment, thereby allowing for easier cleaning of the cooking utensil and eliminating or reducing residue on the surface of the cooking utensil after washing. Furthermore, while not wishing to be bound by theory, because of its low surface tension and high spreading capability, the silicone polymer may be coating oil droplets as the cookware release composition is dispensed onto the cooking utensil surface, thereby reducing exposure of the oil to air and hence reducing oil oxidation and polymerization. Regardless of the precise mechanism, by combining the silicone polymer with the aforementioned one or more edible oils, it was surprisingly discovered that cookware release compositions could be formulated with enhanced resistance to residue buildup on cooking utensil surfaces.

In addition to helping prevent or reduce residue on cooking utensil surfaces, the silicone polymer also contributes to the food release or non-stick properties, resulting from its film forming ability, surface activity, and lubrication properties. Furthermore, the silicone polymer can help prevent or reduce foaming of the cookware release composition during spraying and during cooking. The silicone polymer can also eliminate or lower the risk of clogging of the cookware release composition container nozzle by reducing the foamed composition that might stick to the front of the nozzle after spraying.

The silicone polymer can be present in the cookware release composition at such a level as to have no detectable taste, aroma, or flavor. The cookware release composition can comprise silicone polymer in the amount of from about 50 parts per million (ppm) to about 2,000 ppm, in another embodiment from about 200 ppm to about 1800 ppm, in yet another embodiment from about 400 ppm to about 1600 ppm, in another embodiment from about 800 ppm to about 1500 ppm, in a further embodiment from about 1100 ppm to about 1400 ppm, in another embodiment from about 1200 ppm to about 1500 ppm, in a further embodiment from about 1300 ppm to about 1500 ppm, and in yet another embodiment from about 1400 ppm to about 1500 ppm. In another embodiment, the cookware release composition comprises greater than about 1000 ppm silicone polymer, in another embodiment the cookware release composition comprises greater than about 1100 ppm silicone polymer, and in a further embodiment the cookware release composition comprises greater than about 1200 ppm silicone polymer, and in a further embodiment the cookware release composition comprises greater than about 1300 ppm silicone polymer, and in a further embodiment the cookware release composition comprises greater than about 1400 ppm silicone polymer.

As described, silicone polymers can include the family of organosiloxane polymers characterized by a repeating silicon-oxygen-silicon (Si—O—Si) backbone with organic radicals attached to the silicon atoms. Non-limiting examples of organic radicals can include methyl groups, hydrogen groups, alkyl groups, allyl groups, glycol ether groups, hydroxyl groups, epoxy groups, alkoxy groups, carboxy groups, amino groups, and combinations thereof. In an embodiment, the silicone polymer can be polydimethylsiloxane (PDMS). PDMS is a silicone polymer where methyl groups are linked to the silicon atoms. PDMS is also referred to as dimethyl polysiloxane (DMPS), dimethyl silicone, dimethicone, and silicone oil. In an embodiment, the PDMS has a fluid viscosity from about 50 to about 1,000 centistokes at 77° F. (25° C.), in another embodiment from about 200 to about 500 centistokes, and in yet another embodiment a viscosity of about 350 centistokes at 77° F. (25° C.). Suitable commercially available PDMS includes XIAMETER® PMX-200 Silicone Fluid (350 cSt, Food Grade) available from Dow Corning Corporation (Midland, Mich.) and PSF-350 cSt Food Grade available from Clearco Products (Bensalem, Pa.).

### Emulsifier

The cookware release composition of the present invention can comprise an emulsifier. On one embodiment, the emulsifier functions as a non-stick agent. The cookware release composition can comprise an emulsifier in the amount of from about 1% to about 20%, by weight of the composition, in one embodiment, and in another embodiment from about 2% to about 15%, by weight of the composition, in another embodiment from about 3% to about 12%, by weight of the composition, in a further embodiment from about 4% to about 10%, by weight of the composition, in yet another embodiment from about 5% to about 8%, by weight of the composition, and in another embodiment from about 5.5% to about 6.5%, by weight of the composition. The cookware release composition can comprise an emulsifier in the amount of from about 1% to about 20%, by weight of the composition, in one embodiment, and in another embodiment from about 1% to about 10%, by weight of the composition, and in another embodiment from about 4% to about 7%, by weight of the composition.

Emulsifiers have an amphiphilic structure, with a hydrophilic (polar) part and a lipophilic (non-polar) part. The hydrophilic portion of the emulsifier is attracted to most cooking utensil surfaces, thereby helping to form a layer of the cookware release composition over the surface that reduces the tendency for food to adhere to the cooking utensil surface. The lipophilic portion allows the emulsifier to dissolve in, and interact with, the one or more edible oils of the composition. The emulsifier can also favorably enhance the interaction of the oil with food products and, in many cases, interact with the food itself to provide desirable flavor enhancement and help provide desirable browning during cooking.

Non-limiting examples of emulsifiers can include lecithin, crude lecithin, refined lecithin, fluidized lecithin, filtered lecithin, bleached lecithin, fractionated lecithin, modified lecithin, hydroxylated lecithin, hydrolyzed lecithin, acylated or acetylated lecithin, de-oiled lecithin, lysolecithin, single pure components of lecithin (such as phosphatidylcholine, phosphatidylinositol, phosphatidylethanolamine, phosphatidylserine, and phosphatidic acid and its salts), monoglycerides, diglycerides, phosphated mono- and diglycerides, diacetyl tartaric esters of mono- and diglycerides, ethoxylated mono- and diglycerides, acetylated monoglycerides, succinylated monoglycerides, fatty acid esters of polyglycerol, polyethylene glycol fatty acid esters, propylene glycol fatty acid esters, fatty acid esters of sugar compounds such as sucrose, fatty acid esters of sorbitan, citric acid esters of mono- and diglycerides, lactic acid esters of mono- and diglycerides, lactylic esters of fatty acids and their salts (sodium and calcium), succistearin, and combinations thereof.

In certain embodiments, the emulsifier can comprise one or more lecithins, which includes refined, fluid, de-oiled, filtered, bleached, and fractionated lecithins. Lecithin is a generic name for a class of phospholipids that are mixed esters of glycerol esterified with fatty acids and with phosphoric acid. The phosphoric acid is, in turn, combined with a basic nitrogen containing compound, such as choline, serine, or ethanolamine, or with a non-nitrogen containing compound such as inositol. Most of the performance benefits of lecithins are derived from the surface activity of the phospholipids (phosphatidylcholine, phosphatidylethanolamine, phosphatidylinositol, phosphatidylserine, and phosphatidic acid). Lecithins are characterized by the Acetone Insolubles (AI), which is a measurement in percent of the content of phospholipids and glycolipids. The higher the AI value, the greater the content of surface active phospholipids and glycolipids in the lecithin preparation. Lecithins may be derived from various plant and animal sources, such as soybeans, sunflowers, or egg yolk. Lecithins promote separation of food from the surfaces of cooking utensils.

In other embodiments, the emulsifier can comprise one or more modified lecithins, which includes hydrolyzed, hydroxylated, and acetylated lecithins. In still other embodiments, the emulsifier can comprise one or more standard lecithins and one or more modified lecithins.

Suitable commercially available lecithins include CENTROPHASE® 64CX from Central Soya Company, Inc. (Decatur, Ind.), Solec™ soy lecithin from The Solae Company (St. Louis, Mo.), ALCOLEC® LV-30 from American Lecithin Company (Oxford, Conn.), and BEAKIN™ LV1 from ADM (Decatur, Ill.). Suitable commercially available acetylated lecithins include CENTROPHASE® HR from the Central Soya Company, Inc. (Decatur, Ind.) and SOLEC™ HR from The Solae Company (St. Louis, Mo.).

In one embodiment, the emulsifier of the cookware release composition can include from about 75% to about 99% lecithin. The emulsifier of the cookware release composition can include from about 80% to about 95% lecithin. The emulsifier of the cookware release composition can include from about 85% to about 95% lecithin. The emulsifier of the cookware release composition can include about 90% lecithin. In one aspect, the emulsifier includes lecithin from about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% to about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%.

The emulsifier of the cookware release composition can include from about 1% to about 25% phosphate mono-diglyceride (PMDG). The emulsifier of the cookware release composition can include from about 5% to about 20% PMDG. The emulsifier of the cookware release composition can include 5% to about 15% PMDG. The emulsifier of the cookware release composition can include about 10% PMDG. The emulsifier of the cookware release composition can include PMDG from about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25% to about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%.

The emulsifier of the cookware release composition can include a lecithin to PMDG ratio from about 3:1 to about 99:1. The emulsifier of the cookware release composition can include a lecithin to PMDG ratio from about 5:1 to about 20:1. The emulsifier of the cookware release composition can include a lecithin to PMDG ratio from about 17:3 to about 20:1. The emulsifier of the cookware release composition can include a lecithin to PMDG ratio from about 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 30:1, 40:1, 50:1, 60:1, 70:1, 80:1, 90:1, 99:1 to about 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 30:1, 40:1, 50:1, 60:1, 70:1, 80:1, 90:1, 99:1.

### Other Ingredients

In one embodiment, the cookware release compositions of the present invention can comprise other ingredients. Non-limiting examples of other ingredients can include salt, flavoring agents, antioxidants, chelating agents, nutrients, natural and artificial sweeteners, flavor precursors, edible acids, fumed silica, free fatty acids, viscosity-reducing agents, preservatives, crystallization inhibitors, coloring agents, anti-foaming agents, food grade blocking agents, emulsifying agents, water, and combinations thereof. The cookware release compositions can comprise other ingredients in the amount of from about 0.001% to about 20%, by weight of the composition, in another embodiment from about 0.002% to about 15%, by weight of the composition, in a further embodiment from about 0.01% to about 10%, by weight of the composition, and in yet another embodiment from about 0.01% to about 1%, by weight of the composition.

Non-limiting examples of flavoring agents can include natural and artificial meat flavors, butter flavors, olive oil flavor, fried flavor notes, spicy flavors, tangy flavors, lemon flavors, garlic flavors, herb flavors, and combinations thereof.

Non-limiting examples of antioxidants can include ascorbic acid, ascorbyl palmitate, tocopherols, tertiary butylhydroquinone (TBHQ), butylated hydroxyanisole (BHA), butylated hydroxytoluene (BHT), propyl gallate, rosemary extract, green tea extract, other plant, spice, or herbal extracts or essential oils, and combinations thereof.

Non-limiting examples of chelating agents can include citric acid, malic acid, phosphoric acid, polyphosphates such as sodium hexametaphosphate, and combinations thereof.

Non-limiting examples of nutrients can include amino acids, vitamins, carotenoids, minerals, and combinations thereof.

Non-limiting examples of vitamins can include vitamin A, vitamin D, vitamin K, vitamin E, vitamin C, the B vitamins, and combinations thereof.

Non-limiting examples of edible acids can include citric acid, malic acid, and phosphoric acid.

Non-limiting examples of viscosity-reducing agents include ethyl alcohol. For example, 200-proof or 190-proof ethanol can be incorporated into the cookware release composition to lower fluid viscosity and as a clarifying agent. In an embodiment, ethyl alcohol may be added to the cookware release composition at up to about 20% by weight of the composition, in another embodiment at up to about 15% by weight of the composition, and in yet another embodiment at up to about 10% by weight of the composition.

Non-limiting examples of preservatives include sodium benzoate, calcium propionate, sorbic acid or salts of sorbic acid, and combinations thereof. Salts of sorbic acid can include sodium sorbate, potassium sorbate, and combinations thereof.

Non-limiting examples of crystallization inhibiting agents include polyglycerol esters.

Non-limiting examples of coloring agents include beta-carotene, annatto extract, and combinations thereof.

The cookware release composition can also include suspending aids which can include fumed silica (silicon dioxide), free fatty acids, and combinations thereof.

### Components of the Article of Commerce

In one embodiment of the present invention, the cookware release composition is provided in a container having a set of usage instructions and/or one or more marketing claim statements associated therewith. Any container from which the cookware release composition can be dispensed, such as by pouring, spraying, scooping, or spreading, is suitable. Suitable containers include, but are not limited to, containers having metal, glass, plastic, or multilayer constructions, including squeezable constructions, and having actuators, aerosol valves, spray nozzles, spray caps, screw caps, snap caps, and/or pouring spouts. In one embodiment, the cookware release composition is provided in a pump spray bottle. In another embodiment, the cookware release composition is provided in an aerosol spray container along with a suitable propellant to aid in dispensing the composition from the container when the valve is opened. The cookware release composition and propellant may be in contact with each other in the container, or they may be separated from each other by a flexible bag or pouch contained within an outer container; e.g. with the cookware release composition contained inside the flexible bag and the propellant present in the space between the exterior of the bag and the outer container (referred to as “bag-on-valve” or “bag-in-container” system).

Suitable food-grade propellants can include pressurized gases, liquefied hydrocarbons, and mixtures thereof. Non-limiting examples of liquefied gases include propane, n-butane, isobutane, and combinations thereof. Non-limiting examples of compressed gases include nitrous oxide, carbon dioxide, nitrogen, compressed air, and combinations thereof. Compressed air would typically only be used with the “bag-on-valve” system previously described. In specific embodiments, A-70, A-55, and/or BP-40 propellants can be used. A-70 is a blend of two or more of n-butane, isobutane, and propane. Compressed gases can be included in the cookware release composition at from about 10% to about 20% by weight of the cookware release composition, or from about 14% to about 18%, or about 16%.

In certain embodiments, aerosol containers can be filled with the cookware release composition and propellant using the “under-the-cup” filling process (also called “undercap” filling). In this process, the filling head of a rotary filling machine loads the container with the cookware release composition and places the valve on the container. The filling head then evacuates air from the container, after which propellant is added to the container through a port that passes underneath the valve cup. The valve is then crimped into place onto the container, an actuator is placed on the valve, and a protective over cap placed on the container if desired.

The usage instructions and/or one or more marketing claim statements can be either printed on the container itself, on a label or sticker attached to the container, or presented in a different manner including, but not limited to, brochures, printed advertisements, electronic advertisements, broadcast or internet advertisements, or other media including social media, so as to communicate the set of instructions and/or claim statements to a consumer of the composition in the container. In one embodiment, the claim statement relates to or refers to “low residue” or “no residue” or “easy cleaning”.

### Test Methods

### 1. Measurement of Residue on Glass Cooking Utensil Method

A. Materials and Equipment:
Cooking Utensil: CorningWare® Simply Lite™ glass bakeware (9″/22.5 cm pie plate; edge to edge diameter=26 cm; white color; Product #1078888; World Kitchen, LLC, Greencastle, Pa.; www.shopworldkitchen.com). Note: Before use, dishes are hand washed with soap and water (Dawn® detergent), rinsed with water (final rinse with de-ionized water), and air-dried.
Oven: VWR Horizontal Air Flow Oven (Model #1330FM; Sheldon Manufacturing, Inc., Cornelius, Oreg.; VWR catalog #52201-069). Temperature range=40-240° C. (104-464° F.). Note: Temperature calibration should be checked and recorded daily prior to testing using a calibrated thermocouple thermometer (e.g. Model EA15 Thermocouple Datalogging Thermometer with Type J thermocouple, Extech Instruments Corporation, www.extech.com). The oven air temperature measured 1-2 inches above the interior shelf should stabilize within +/−1° C. (+/−1.8° F.) of the desired target treatment temperature. If necessary, adjust the oven temperature set point to achieve the proper temperature reading.
Balance: 2-place balance (e.g. Ohaus Model #SP402-US; Ohaus Corporation, Pine Brook, N.J.), with a plexiglass cover enclosure.
Automatic Dish Washer: General Electric stainless steel tub dishwasher (Model #GDWF 100RWW); with Cascade® dishwasher detergent (Shine Shield Formula, Action Pacs, 4× concentrated).

B. Procedure:
i) Weigh and record the weight in grams (weight A) of the clean, dry CorningWare® glass bakeware dish described in the materials and equipment section above.
ii) Place the glass dish on a horizontal, flat surface. Shake the aerosol cookware release composition container for 10 seconds and perform a 2-second test spray onto a different surface (e.g. into the sink) to ensure the nozzle is clear, then stop the test spray. Then spray the cookware release composition onto the surface of the dish in order to deliver about 1-1.2 grams of cookware release composition in a nearly uniform distribution over the entire dish surface (this result typically occurs when the aerosol can is held at about a 30-45° angle from horizontal, with the nozzle about 9-12 inches above the dish surface and the cookware release composition is then sprayed in a “Z” pattern for 1-2 seconds). The appearance on the dish surface should be a nearly uniform distribution of cookware release composition spray droplets covering the entire dish surface edge-to-edge.
iii) Weigh and record the weight in grams of the dish +cookware release composition spray (weight B). Calculate the grams of cookware release composition applied to the surface (weight C) by subtracting the initial weight of the clean dish (C 32B-A).
iv) Place the dish with the nearly uniform distribution of cookware release composition covering the surface in the oven that has been pre-equilibrated for at least 1 hour at 400° F. and set a timer for 40 minutes. Note: Heat only one dish at a time so as to maintain good temperature control. After opening and closing the oven door to insert the dish, the oven temperature reading should return to the set point within 2-3 minutes.
v) After completion of the 40 minute heat treatment, remove the dish and allow it to cool on the lab bench at room temperature (70±2° F.) until the dish reaches room temperature (this typically takes about 30-60 minutes). Then place the dish in the bottom rack of the GE dishwasher at about a 45 degree angle with the horizontal and with the surface that was sprayed with the cookware release composition facing down. Wash two dishes per load, one dish at the front and one dish at the back of the bottom dishwasher rack, with the surface that was sprayed with the cookware release composition directed toward the bottom-center of the dishwasher interior. Add one Shine Shield Formula Cascade® Dishwasher Detergent ActionPac™ (4× concentrated) to the detergent compartment. Run hot water from the faucet to purge the hot water line of cold water, then measure and record the hot water temperature from the faucet prior to running the dishwasher (must be 120-130° F.). Run a “Normal Wash” with a “Heated Dry” cycle (the run time for both cycles is about 90-100 minutes).
vi) Upon completion of the dishwasher wash and dry cycles, remove the washed dishes and place the dishes in a fume hood with the sash closed and a circulating air flow to ensure the dishes are thoroughly dry and cooled to room temperature (this generally takes about 30-60 minutes) prior to the final weighing.
vii) Weigh and record the final dish weight (weight D). Calculate and record the weight of residue (weight E) remaining on the dish surface by subtracting the initial weight of the clean dish from the final dish weight (E=D−A). Calculate and record the % of cookware release composition remaining as residue on the dish surface by dividing the residue weight (E) by the grams of cookware release composition applied to the surface (C) and multiplying by 100 (% of cookware release composition as residue=[E/C]×100).
viii) Record the appearance of the dish surface by taking a photograph.

### 2. Measurement of Residue on Aluminum Baking Utensil Method

A. Materials and Equipment:
Cooking utensil: NordicWare® Baker's Quarter Sheet (9″×13″, natural aluminum commercial bakeware, Product #N7801, Catalog #45300, NordicWare, Minneapolis, Minn.; www.nordicware.com). Note: Before use, aluminum baking sheets are hand washed with hot soapy water (Dawn® detergent), rinsed with water (final rinse with de-ionized water), thoroughly dried in the oven to evaporate all residual water, and cooled to room temperature.
Oven: VWR Horizontal Air Flow Oven (Model #1330FM; Sheldon Manufacturing, Inc., Cornelius, Oreg.; VWR catalog #52201-069). Temperature range=40-240° C. (104-464° F.). Note: Temperature calibration should be checked and recorded daily prior to testing using a calibrated thermocouple thermometer (e.g. Model EA15 Thermocouple Datalogging Thermometer with Type J thermocouple, Extech Instruments Corporation, www.extech.com). The oven air temperature measured 1-2 inches above the interior shelf should stabilize within +/−1° C. (+/−1.8° F.) of the desired target treatment temperature. If necessary, adjust the oven temperature set point to achieve the proper temperature reading.
Balance: 1-place balance (e.g. Mettler PC4000), with a plexiglass cover enclosure.

B. Procedure:
i) Weigh and record the weight in grams (weight A) of the clean, dry NordicWare® aluminum Baker's Quarter Sheet described in the materials and equipment section above.
ii) Place the aluminum baking sheet on a horizontal, flat surface. Shake the aerosol cookware release composition container for 10 seconds and perform a 2-second test spray onto a different surface (e.g. into the sink) to ensure the nozzle is clear, then stop the test spray. Then spray the cookware release composition onto the surface of the baking sheet in order to deliver about 1-1.2 grams of cookware release composition in a nearly uniform distribution over the entire sheet surface (this result typically occurs when the aerosol can is held at about a 30-45° angle from horizontal, with the nozzle about 9-12 inches above the sheet surface and the cookware release composition is then sprayed in a “Z” pattern for 1-2 seconds). The appearance on the sheet surface should be a nearly uniform distribution of cookware release composition spray droplets covering the entire sheet surface edge-to-edge.
iii) Weigh and record the weight in grams of the baking sheet+cookware release composition spray (weight B). Calculate the grams of cookware release composition applied to the surface (weight C) by subtracting the initial weight of the clean sheet (C=B−A).
iv) Place the baking sheet with the nearly uniform distribution of cookware release composition covering the surface in the oven that has been pre-equilibrated for at least 1 hour at 375° F. and set a timer for 40 minutes. Note: Heat only one sheet at a time so as to maintain good temperature control. After opening and closing the oven door to insert the sheet, the oven temperature reading should return to the set point within 2-3 minutes.
v) After completion of the 40 minute heat treatment, remove the baking sheet and allow it to cool on the lab bench at room temperature (70±2° F.) until the sheet reaches room temperature (this typically takes about 30-60 minutes). Then hand wash the baking sheet in hot soapy water according to the following protocol (Note: manufacturer usage instructions do not recommend washing natural aluminum baking sheets in an automatic dishwasher).
vi) Rinse the surface of the baking sheet that was sprayed with the cookware release composition with hot tap water (120-130° F.) for 30 seconds.
vii) Soak the baking sheet in hot soapy water for 4 minutes with the surface that was sprayed with the cookware release composition facing up. The hot soapy water is prepared using 10 L of hot tap water (120-130° F.) and 10 ml Dawn® dish detergent, followed by hand mixing for several seconds to disperse the detergent.
viii) For 1 minute, vigorously wipe down the surface of the baking sheet that was sprayed with the cookware release composition with 3 Bounty® Basic paper towels (one-ply sheets; 11 inches×10.4 inches) stacked together, folded into an approximate square (dimensions of about 5.5 inches×5.5 inches), and wetted with the hot soapy water. Immerse the baking sheet repeatedly several times in the hot soapy water during the minute of vigorous wiping.
ix) Rinse both sides of the baking sheet with hot tap water (120-130° F.) for 1 minute, turning the sheet repeatedly during rinsing to completely rinse off the detergent from both sides. Then rinse both sides for 30 seconds with de-ionized water.
x) Air dry the washed baking sheet in a fume hood with the sash closed and a circulating air flow (this usually takes about 30-60 minutes).
xi) Place the washed baking sheet back in the oven at 375° F. for 40 minutes. Note: this second heat treatment will thoroughly evaporate any residual water.
xii) Upon completion of the second heat treatment, remove the baking sheet and allow it to cool on the lab bench at room temperature (70±2° F.) until the cookware reaches room temperature (this generally takes about 30-60 minutes).
xiii) Weigh and record the final sheet weight (weight D). Calculate and record the weight of residue (weight E) remaining on the sheet surface by subtracting the initial weight of the clean sheet from the final sheet weight (E=D−A). Calculate and record the % of cookware release composition remaining as residue on the sheet surface by dividing the residue weight (E) by the grams of cookware release composition applied to the surface (C) and multiplying by 100 (% of cookware release composition as residue=[E/C]×100).
xiv) Record the appearance of the baking sheet surface by taking a photograph.

### EXAMPLES

### Example 1

Six cookware release compositions are prepared by blending the appropriate ingredients until a homogeneous composition is obtained (see Tables below for the formulations). They are named Compositions A through F as follows:

Composition A: Canola Oil (without silicone polymer)

Composition B: Canola Oil and Silicone Polymer

Composition C: High-Oleic Canola Oil and Silicone Polymer

Composition D: High-Oleic Sunflower Oil and Silicone Polymer

Composition E: High-Oleic Canola Oil, Coconut Oil, and Silicone Polymer

Composition F: High-Oleic Canola Oil, Super Palm Olein, and Silicone Polymer

| | Composition A | | Composition B | |
|---|---|---|---|---|
| Ingredient | Wt % | Grams | Wt % | Grams |
| Canola Oil RBD | 91.91 | 413.59 | 93.89 | 422.50 |
| Soy Lecithin (fluid; 50-54% | 5.95 | 26.78 | 5.95 | 26.78 |
| Acetone Insolubles) | | | | |
| Soy Fatty Acids | 0.43 | 1.93 | — | — |
| Water (deionized) | 1.70 | 7.65 | — | — |
| Polydimethylsiloxane (350 cSt | — | — | 0.146 | 0.656 |
| viscosity) | | | | |
| Rosemary Extract | 0.012 | 0.054 | 0.012 | 0.054 |
| TOTAL | 100.0 | 450.0 | 100.0 | 450.0 |

| | Composition C | | Composition D | |
|---|---|---|---|---|
| Ingredient | Wt % | Grams | Wt % | Grams |
| High-Oleic Canola Oil RBD | 93.89 | 422.50 | — | — |
| High-Oleic Sunflower Oil RBD | — | — | 93.89 | 422.50 |
| Soy Lecithin (fluid; 50-54% | 5.95 | 26.78 | 5.95 | 26.78 |
| Acetone Insolubles) | | | | |
| Polydimethylsiloxane (350 cSt | 0.146 | 0.656 | 0.146 | 0.656 |
| viscosity) | | | | |
| Rosemary Extract | 0.012 | 0.054 | 0.012 | 0.054 |
| TOTAL | 100.0 | 450.0 | 100.0 | 450.0 |

| | Composition E | | Composition F | |
|---|---|---|---|---|
| Ingredient | Wt % | Grams | Wt % | Grams |
| High-Oleic Canola Oil RBD | 65.72 | 295.74 | 65.72 | 295.74 |
| Coconut Oil RBD | 28.17 | 126.77 | — | — |
| Super Palm Olein | — | — | 28.17 | 126.77 |
| Soy Lecithin (fluid; 50-54% | 5.95 | 26.78 | 5.95 | 26.78 |
| Acetone Insolubles) | | | | |
| Polydimethylsiloxane (350 | 0.146 | 0.656 | 0.146 | 0.656 |
| cSt viscosity) | | | | |
| Rosemary Extract | 0.012 | 0.054 | 0.012 | 0.054 |
| TOTAL | 100.0 | 450.0 | 100.0 | 450.0 |

The canola oil RBD used in Compositions A and B is comprised of 18.4% by weight linoleic acid (C18:2) and 7.9% by weight linolenic acid (C18:2), for a total polyunsaturated fatty acid content of 26.3%. The high-oleic canola oil used in Compositions C, E, and F is comprised of 73.6% by weight oleic acid, 13.7% by weight linoleic acid, and 1.5% by weight linolenic acid (total polyunsaturated fatty acids equal to 15.2% by weight). The high-oleic sunflower oil used in Composition D is comprised of 84.8% by weight oleic acid, 6.9% by weight linoleic acid, and 0.3% by weight linolenic acid (total polyunsaturated fatty acids equal to 7.2% by weight). The coconut oil used in Composition E is comprised of about 2% by weight linoleic acid (total polyunsaturated fatty acids equal to 2% by weight). The blend of high-oleic canola oil and coconut oil used in Composition E is comprised of about 11.2% by weight polyunsaturated fatty acids. The super palm olein used in Composition F is comprised of about 12.5% by weight polyunsaturated fatty acids. The blend of high-oleic canola oil and super palm olein used in Composition F is comprised of about 14.4% by weight polyunsaturated fatty acids.

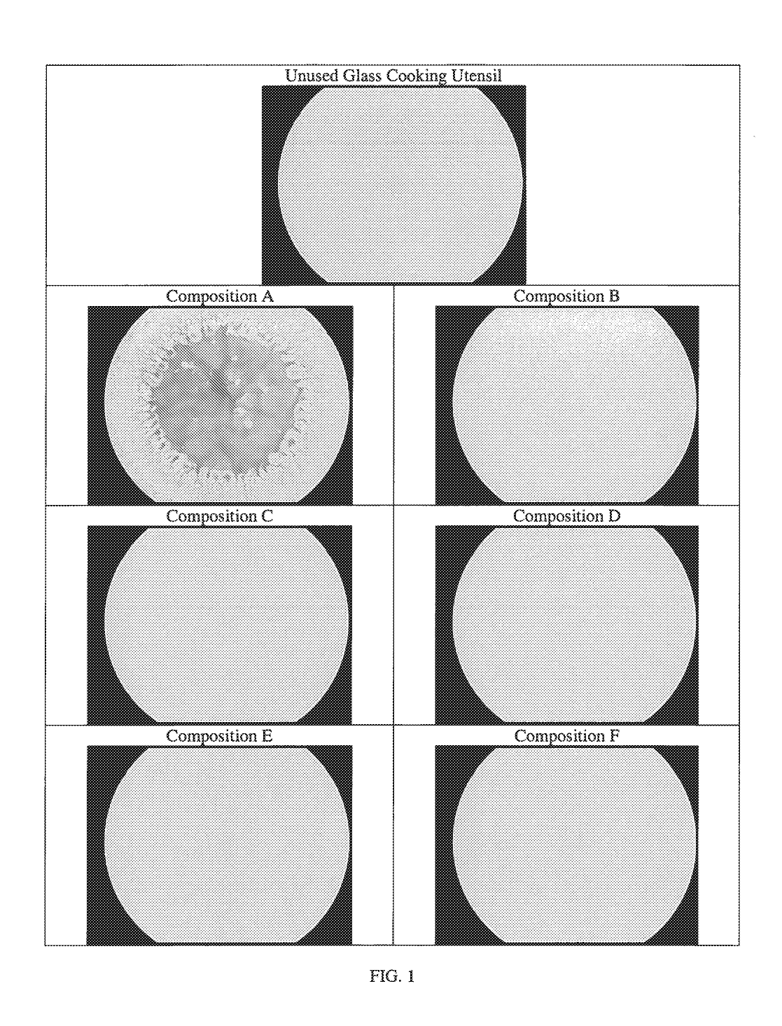

Each composition is packaged into a metal can with a valve and actuator and pressurized with A-70 hydrocarbon propellant at a ratio of 84% by weight cookware release composition and 16% by weight A-70 propellant. The resulting packaged aerosol cookware release compositions are used to measure the amount of residue on glass cooking utensil according to the Measurement of Residue on Glass Cooking Utensil Method. The results are summarized in the following table and in FIG. 1.

| | Cookware Release Composition | | | | | |
|---|---|---|---|---|---|---|
| | A | B | C | D | E | F |
| Grams of cookware | 1.04 | 1.08 | 0.99 | 1.06 | 0.99 | 1.05 |
| release composition | | | | | | |
| applied to surface | | | | | | |
| Grams of residue after | 0.82 | 0.27 | 0.11 | 0.06 | 0.00 | 0.03 |
| washing and drying | | | | | | |
| % of cookware release | 78.9% | 25.0% | 11.1% | 5.7% | 0% | 2.9% |
| composition as residue | | | | | | |

The results indicate that cookware release compositions used as Compositions B, C, D, E, and F develop lower amounts of cookware release composition residue on glass cooking utensils after washing compared to Composition A. Furthermore, the results indicate that Compositions C, D, E, and F develop lower amounts of cookware release composition residue on glass cooking utensils compared to Composition B. In fact, in this example, Composition E develops no measureable cookware release composition residue, and composition F develops only a minor amount of about 0.03 grams. FIG. 1 includes photographs of the glass cooking utensil following spraying of the cookware release composition followed by the heat and wash process as described in the Measurement of Residue on Glass Cooking Utensil Method. FIG. 1 shows compositions A, B, C, D, E, and F. FIG. 1 shows that compositions B, C, D, E, and F develop lower amounts of cookware release composition residue on glass cooking utensils as compared to Composition A. FIG. 1 also shows that Compositions C, D, E, and F develop lower amounts of cookware release composition residue on glass cooking utensils compared to Composition B. In addition, FIG. 1 shows that Compositions E and F develop at most a minor amount of cookware release composition residue on glass cooking utensils after washing.

### Example 2

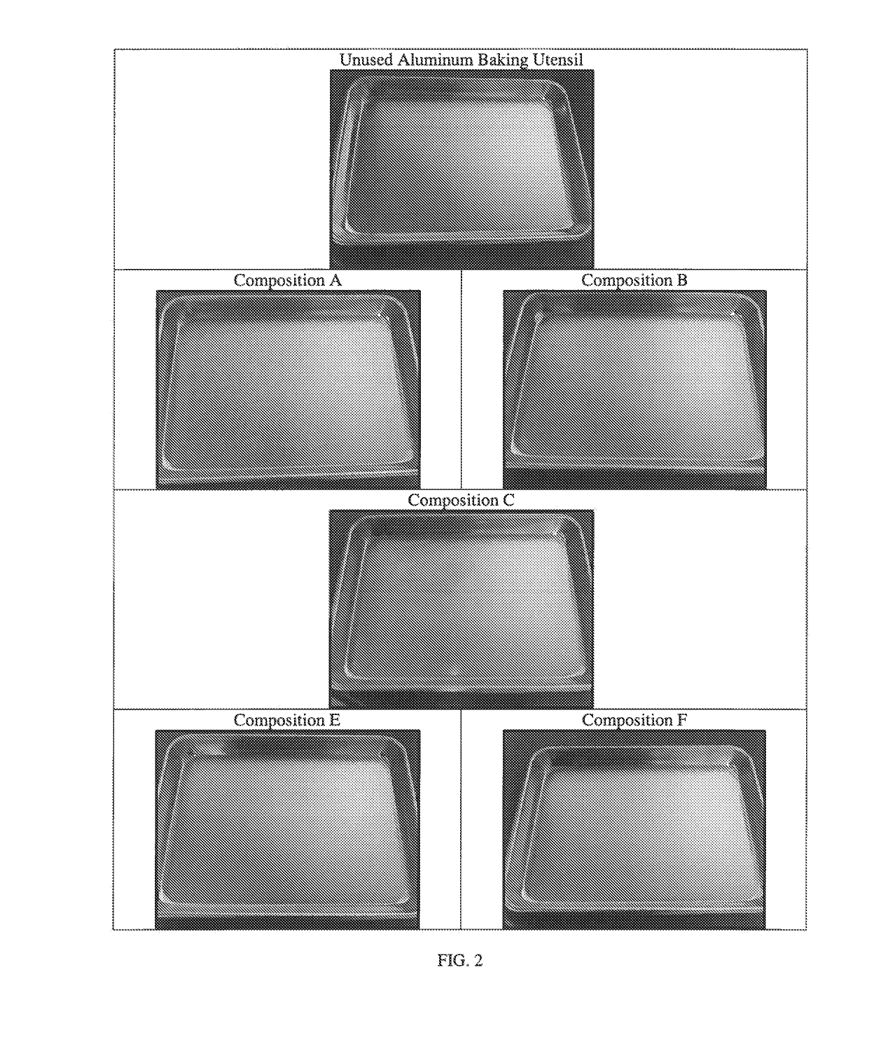

Cookware release compositions A, B, C, E, and F from Example 1 above, after packaging into metal cans with valve, actuator, and propellant as described, are used to measure the amount of residue on an aluminum baking sheet according to Measurement of Residue on Aluminum Baking Utensil Method. The results are summarized in the following table and in FIG. 2.

Cookware Release
Composition

| | A | B | C | E | F |
|---|---|---|---|---|---|
| Grams of cookware | 1.0 | 1.0 | 1.1 | 1.1 | 1.0 |
| release composition | | | | | |
| applied to surface | | | | | |
| Grams of residue | 0.7 | 0.4 | 0.3 | 0.0 | 0.0 |
| after washing and | | | | | |
| drying | | | | | |
| % of cookware | 70% | 40% | 27% | 0% | 0% |
| release composition | | | | | |
| as residue | | | | | |

The results indicate that the cookware release compositions used as Compositions B,

C, E, and F develop lower amounts of cookware release composition residue on the aluminum baking sheets after washing compared to Composition A. Furthermore, the results indicate that Compositions C, E, and F develop lower amounts of cookware release composition residue on the aluminum baking sheets compared to Composition B. In fact, in this example, Compositions E and F develop no measureable cookware release composition residue on the aluminum baking utensils. FIG. 2 includes photographs of the aluminum bakeware following spraying of the cookware release composition followed by the heat and wash process as described in the Measurement of Residue on Aluminum Cooking Utensil Method. FIG. 2 shows compositions A, B, C, E, and F. FIG. 2 shows that Compositions B, C, E, and F develop lower amounts of cookware release composition residue on the aluminum baking utensils as compared to Composition A. FIG. 2 also shows that Compositions C, E, and F develop lower amounts of cookware release composition residue on aluminum baking utensils compared to Composition B. In addition, FIG. 2 shows that Compositions E and F develop little if any cookware release composition residue on aluminum baking utensils after washing.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1-20. (canceled)

21. An article of commerce, comprising
a container;
at least one aerosol valve;
a spray nozzle; and
a composition in the container, wherein the composition includes:
about 10% to about 20% aerosol, and
about 80% to about 90% of a cookware release composition, wherein the cookware release composition includes:
canola oil from about 40% to about 50% by total weight of the cookware release composition,
a palm oil and coconut oil blend from about 40% to about 50% by total weight of the cookware release composition, and
a silicone polymer, wherein the silicone polymer is present at greater than about 1200 ppm and less than about 2,000 ppm by total weight of the cookware release composition.

22. The article of commerce of claim 21, wherein the cookware release composition further comprises lecithin.

23. The article of commerce of claim 22, wherein the lecithin includes soy lecithin.

24. The article of commerce of claim 22, wherein the lecithin is about 2% to about 10% by total weight of the cookware release composition.

25. The article of commerce of claim 21, wherein the palm oil includes palm olein.

26. The article of commerce of claim 25, wherein the palm olein includes fractionated palm olein.

27. The article of commerce of claim 21, wherein the silicone polymer includes dimethylpolysiloxane.

28. The article of commerce of claim 21, wherein the silicone polymer is present at greater than about 1300 ppm and less than about 1600 ppm by total weight of the cookware release composition.

29. The article of commerce of claim 21, wherein the cookware release composition further comprises rosemary extract.

30. An article of commerce, comprising
an aerosol container;
a composition in the container, wherein the composition includes:
about 10% to about 20% aerosol, and
about 80% to about 90% of a cookware release composition, wherein the cookware release composition includes:
a blend of canola oil, palm oil and coconut oil from about 85% to about 95% by total weight of the cookware release composition, and
a silicone polymer, wherein the silicone polymer is present at greater than about 1200 ppm and less than about 3,000 ppm by total weight of the cookware release composition.

31. The article of commerce of claim 30, wherein the cookware release composition further comprises lecithin.

32. The article of commerce of claim 31, wherein the lecithin includes soy lecithin.

33. The article of commerce of claim 31, wherein the lecithin is about 2% to about 10% by total weight of the cookware release composition.

34. The article of commerce of claim 30, wherein the palm oil includes palm olein.

35. The article of commerce of claim 34, wherein the palm olein includes fractionated palm olein.

36. The article of commerce of claim 30, wherein the silicone polymer includes dimethylpolysiloxane.

37. The article of commerce of claim 30, wherein the silicone polymer is present at greater than about 1300 ppm and less than about 1600 ppm by total weight of the cookware release composition.

38. The article of commerce of claim 30, wherein the cookware release composition further comprises rosemary extract.

39. An article of commerce, comprising
an aerosol container;
a composition in the container, wherein the composition includes:
aerosol, and
a cookware release composition, wherein the cookware release composition includes:
a blend of canola oil, palm oil and coconut oil from about 85% to about 95% by total weight of the cookware release composition, and
a silicone polymer, wherein said silicone polymer is present at greater than 1200 ppm and less than about 3,000 ppm by total weight of the cookware release composition.

40. The article of commerce of claim 39, wherein the silicone polymer is present at greater than about 1300 ppm and less than about 1600 ppm by total weight of the cookware release composition.
